(19) United States
(12) Patent Application Publication
(10) Pub. No.: US 2005/0163671 A1
(43) Pub. Date: Jul. 28, 2005

(54) Aromatic apparatus for plumbing fixtures

(76) Inventor: Robert Krottner, Visalia, CA (US)

Correspondence Address: Richard A. Ryan;RYAN & ENGNATH, Suite 104, 8469 N. Millbrook, Fresno, CA, 93720, US

(21) Appl. No.: 10/765,530

(22) Filed: Jan. 27, 2004

(51) Int. Cl. B32B 5/02

(52) U.S. Cl. 422/125

(57) ABSTRACT

An aromatic apparatus for use with plumbing fixtures such as shower heads and pipes that carry warm or hot fluid, such as water. The aromatic apparatus includes an aromatic component that is configured to be disposed at least partially around a tubular member associated with the plumbing fixture and to emanate a desired aroma when warm or hot fluid flows through the tubular member. The aromatic component can be a solid or semi-solid material, such as silicone, that is impregnated or coated with a volatile fragrance. The aromatic component can also be in the form of gelled beads, crystals or a liquid. The shower head configuration includes a chamber for holding the aromatic component and one or more openings for allowing the aroma to emanate from the shower head. The pipe configuration includes a closure mechanism or a snap-on clip member for securing the aromatic component to the pipe.

### CROSS-REFERENCE TO RELATED APPLICATIONS

Not Applicable.

### BACKGROUND OF THE INVENTION

A. Field of the Invention

The field of the present invention relates generally to apparatuses used to generate or emanate an aroma. More specifically, the present invention relates to aroma apparatuses that are configured to cooperate with plumbing fixtures so as to emanate an aroma without the use of electricity, candles or other devices. Even more specifically, the present invention relates to such aroma apparatuses that can be made integral with or attached to various plumbing fixtures to emanate an aroma therefrom.

B. Background

Apparatuses for generating or emanating aromas are commonly known and have been in use for some time. Aroma apparatuses are frequently utilized to emanate aroma into an area, such as a room or the like, to improve the smell of the area or to provide a certain ambiance to the area. Although many aroma apparatuses are configured to emanate a perfume-type aroma, other apparatuses generate aromas based on natural scents, including fruit, vegetable, plant and environmental (i.e., forest, ocean and the like) smells. For purposes of this disclosure, the term “aroma” includes all types of scents and smells, including those that are pleasant, savory or otherwise able to charge an area with a desired smell and modify the environment of the area. Aromas suitable for use with the apparatus of the present invention include such aromas that are used or adaptable for use with bath oils and gels, air fresheners, candles, deodorants and other devices suitable for changing the smell of an area, including rooms and bath waters.

Apparatuses heretofore commonly utilized to generate or emanate an aroma typically require use of an electric or candle heat source, or are placed in and then at least partially dissolve by a liquid, such as a warm or hot bath, or are sprayed from a can or other device. Some aroma apparatuses plug into an electrical outlet and utilize electricity therefrom to generate heat that causes a portion of the apparatus, such as a replaceable cartridge, to emanate the aroma. Alternatively, some heat-source aroma apparatuses are battery powered or derive the heat necessary for emanating the aroma from a light. Examples of such apparatuses can be found in U.S. Pat. No. 4,595,564 to Spector, et al. and U.S. Pat. No. 4,009,384 to Holland. The Spector device is a cartridge-type aroma percolator for emanating an aroma into an area at a relatively high rate. The percolator utilizes an electric heater to boil a solution onto an aroma-based insert to waft an aroma vapor. The Holland device comprises a high temperature resistant material, such as an asbestos sheet, which has been immersed in a solution of scented liquid that is configured to attach to an electric lamp shade. The electric light generates heat that causes the asbestos/scented sheet to emanate an aroma. Other aroma apparatuses require heat to be provided from a candle or other flame source to interact with the aroma portion of the apparatus to emanate the desired aroma into the area. Generally, this type of device includes an aroma material holding portion that is placed above a lit candle. The principal limitation of electric, battery or candle types of apparatuses is that they require the electric, battery or candle sources of heat and, as such, they have are generally not beneficially adaptable to certain situations, particularly use in the bath or shower. In addition, these types of apparatuses require the user to turn the device on and off and/or require replacement of the batteries and candles.

The benefits of providing aroma to a room or area are well known and include the cover-up of unpleasant smells and heightened relaxation. Both of these uses are fully applicable to utilization in the shower, bath or other places where plumbing fixtures are located. For instance, it is commonly believed that certain smells can provide therapeutic benefits, commonly referred to as aromatherapy. U.S. Pat. No. 6,623,511 to Daffer, et al., discloses a personalized therapeutic compartment or capsule that combines a shower system having a plurality of shower nozzles with a source of aroma. A person lies down in the compartment/capsule and is subject to the shower system, aroma and coordinated colors from an interior light source. While significantly less sophisticated, many people enjoy having one or more lit candles in the bathroom when they are taking a shower or bath. Unfortunately, this requires a flame source that can be somewhat incompatible with the shower or bath.

What is needed, therefore, is a aromatic apparatus that is suitable for use in a shower or bath to enhance the shower or bath with the desired aroma. The preferred aromatic apparatus will not require an electric, battery or flame source of heat to generate the aroma. Instead of relying on a separate heat source, the preferred apparatus will interact with the hot water flowing through a plumbing fixture to provide the heat to activate the emanation of aroma. Preferably, the apparatus will be configured such that the source of aroma will not be intermixed with the flowing water (i.e., will not result in aromatic water). The apparatus will allow the user to enjoy his or her shower or bath with aroma that is generated when warm or hot water flows through the plumbing fixture configured with the aromatic apparatus of the present invention.

### SUMMARY OF THE INVENTION

The aromatic apparatus for plumbing fixtures of the present invention solves the problems and provides the benefits identified above. That is to say, the present invention discloses an apparatus that can be beneficially utilized with a pluming fixture to provide a desired aroma for a person utilizing or positioned in the area of the fixture. When used with a shower or bath fixture, the aromatic apparatus of the present invention emanates a selected aroma to enhance the enjoyment and relaxation of the shower or bath. The aromatic apparatus of the present invention generates a selected aroma without the need of an electric, battery or flame heat source by utilizing the warm or hot water flowing through the plumbing fixture. The aromatic apparatus puts aroma in the air without causing the water flowing through the fixture to be intermixed with the aromatic component of the apparatus.

For purposes of this disclosure, the term “plumbing fixture” includes shower and bathtub components, piping systems, inlet pipes and other plumbing components utilized to transfer or outlet water, particularly warm or hot water. In particular, the term plumbing fixture includes shower heads and the pipes that connect to the shower head outside of the wall enclosing the shower and bathtub spouts and any pipes which connect to the spout outside of the wall enclosing the bath. If desired, the term plumbing fixture also includes any specially designed or configured components that can be utilized to carry water and cooperate with the aromatic apparatus of the present invention to generate a desired aroma

In one aspect of the present invention, the aromatic apparatus includes a plumbing fixture having a tubular component associated therewith that is configured to carry a warm or hot fluid, such as water, through the plumbing fixture and an aromatic component at least partially disposed around the tubular component of the plumbing fixture. The aromatic component is configured to emanate a desired aroma when the warm or hot fluid is carried through the tubular component. In one configuration, the aromatic component is a tube or ring-like shape that substantially encircles the tubular component. The aromatic component can be a solid, semi-solid, crystal, bead or liquid material that is coated or impregnated by an aromatic fragrance or the like. The plumbing fixture can be a shower head having an interior chamber with the aromatic component disposed in the chamber. To facilitate the dispersal of the aroma from the aromatic component in the area near the shower, the shower head can include one or more openings in communication with the chamber. The aromatic component can be located on or around a tubular component disposed inside the chamber. In one configuration, the shower head can have a spray cap portion that removably (i.e., threadably) attaches to a base portion with the chamber substantially enclosed therebetween. The removable spray cap allows the user to replace or refill the aromatic component as it is used up or when a different aroma is desired. For liquid aromatic components, the shower head can include an injection port in communication with the chamber. The plumbing fixture can also be a pipe, such as a pipe leading to a shower head, bathtub faucet, sink or other facility, and the aromatic component can be configured to removably attach to the pipe. To facilitate installation, the aromatic component can comprise a closure mechanism, such as ties, wire, hooks and other devices, for securing the aromatic component to the pipe. Alternatively, a clip member can be utilized for securing the aromatic component to the pipe. The clip member should be sized and configured to securely engage the pipe with a snap-on type of action. The clip member can comprise a frame with a pair of end members and one or more transverse members.

Accordingly, the primary objective of the present invention is to disclose an aromatic apparatus for plumbing fixtures that provides the advantages discussed above and that overcomes the disadvantages and limitations associated with presently available aromatic apparatuses.

It is also an important objective of the present invention to provide an aromatic apparatus that does not directly use electricity, battery or flame-generated heat to emanate the desired aroma.

It is also an important objective of the present invention to provide an aromatic apparatus that is configured to cooperate with a plumbing fixture such that the flow of water through the fixture will cause the apparatus to emanate a desired aroma.

It is also an important objective of the present invention to provide an aromatic apparatus that can be utilized as a shower head or can be attached to a tubular object, such as a pipe or bathtub spout, to cause aroma to be dispensed when water flows through the shower head or tubular object without intermixing the aromatic component with the flowing water.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the best modes presently contemplated for carrying out the present invention:

FIG. 1 is an exploded perspective view of the aromatic apparatus of the present invention configured as a shower head with a solid or semi-solid ring shaped aromatic component around the tubular lower section of the spray cap;

FIG. 2 is a side view of the aromatic apparatus of FIG. 1;

FIG. 3 is a cross-sectional side view of a shower head with the aromatic component configured as a plurality of crystals disposed in the shower head;

FIG. 4 is a cross-sectional side view of a shower head with the aromatic component configured as a plurality of beads disposed in the shower head;

FIG. 5 is a cross-sectional side view of a shower head with the aromatic component configured as a liquid disposed in the shower head;

FIG. 6 is an exploded side view of a shower head having a tubular member disposed inside the shower head with the ring shaped aromatic component around the tubular member;

FIG. 7 is a perspective view of an aromatic apparatus comprising a ring shaped aromatic component on a pipe; and

FIG. 8 is a perspective view of an aromatic apparatus comprising an aromatic component attached to a pipe with a clip member.

### DETAILED DESCRIPTION OF THE PREFERRED EMBODIMENTS

With reference to the figures where like elements have been given like numerical designations to facilitate the reader's understanding of the present invention, and particularly with reference to the embodiments of the aromatic apparatus for plumbing fixtures of the present invention illustrated in the figures, the preferred embodiments of the present invention are set forth below. The enclosed figures and drawings are merely illustrative of preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

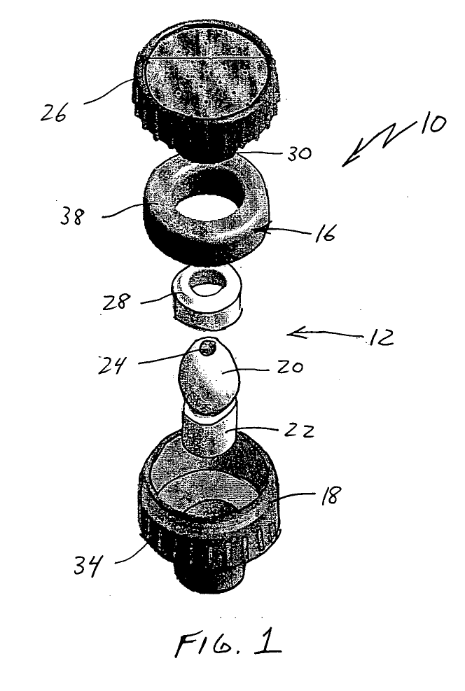

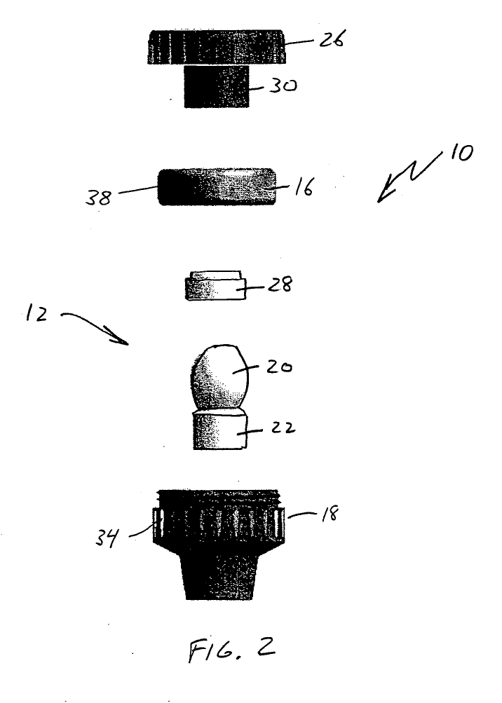

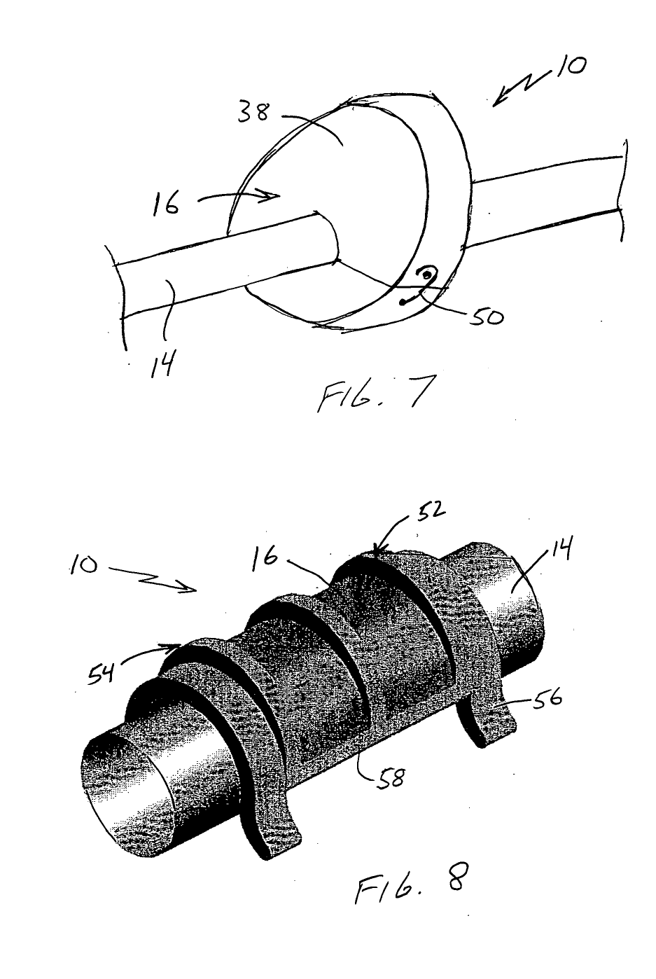

The aromatic apparatus of the present invention, identified generally as 10 in the figures, is configured for use with plumbing fixtures, such as the shower head 12 in FIGS. 1 through 6 and pipe 14 in FIGS. 7 and 8. In the shower head embodiment, the aromatic component 16 is configured for use with a shower head 12 that is adapted to receive aromatic component 16 and cause aromatic component 16 to emanate a preferred aroma when the user utilizes shower head 12 by running warm or hot water therethrough. The typical shower head 12 comprises a base 18 in which is disposed a pivot member 20 having a connector 22 thereon for connecting to the piping system. Although in this particular configuration connector 22 is integral with pivot member 20, other configurations are also possible (i.e., connector 22 part of base 18). As commonly known in the art, pivot member 20 is configured to allow shower head 12 to be pivot relative to the piping system. Pivot member 20 receives water through connector 22 and transmits the water out pivot opening 24 so that it may be discharged from spray cap 26 to spray the user with the water during a shower. Seal 28, which is configured to cooperate both with pivot member 20 and the bottom section 30 of spray cap 26 (best shown in FIG. 2), is sealably disposed between pivot member 20 and spray cap 26 and utilized to facilitate the transfer of water from pivot member 20 to spray cap 26. Seal 28 prevents water from entering into chamber 32 formed between base 18 and spray cap 26. As best shown in FIG. 2, spray cap 26 is configured to be threadably received on base 18 to close the top of chamber 32. In a preferred configuration of shower head 12 for use with the present invention, base 12 and/or spray cap 26 should have one or more openings 34 therein that open to the atmosphere and pass through to chamber 32.

In a preferred embodiment of aromatic apparatus 10 of the present invention, aromatic component 16 is tubular or ring shaped, as best shown in FIG. 1, and configured to substantially surround an interior portion of shower head 12 that carries warm or hot water to spray cap 26. In the configuration shown in FIGS. 1 and 2, aromatic component 16 is shaped and configured to substantially encircle tubular lower section 30 of spray cap 26 such that as water flows from pivot member 20 to spay cap 26 it passes through the center of aromatic component 16 without making any contact with aromatic component 16. Warm or hot water flowing inside pivot member 20 and bottom section 16 of spray cap 26 transfers some of its heat to aromatic component 16 and causes the fragrance thereon or therein to generate the desired aroma. To improve the function of aromatic apparatus 10, lower section 30 of spray cap 26, and to a certain extent pivot member 20, should be made out of materials and configured so as to beneficially transfer heat from the flowing water to aromatic component 16 so as to cause aromatic component 16 to emanate the desired aroma. To facilitate the transfer of the aroma to the atmosphere, base 18 should be configured with one or more openings 34 that allow the aroma to emanate from inside chamber 32. In a preferred embodiment, water flowing from the piping system through connector 22, pivot member 20, lower section 16 of spray cap 26 and out spray cap 26 should not be able to contact aromatic component 16. Contact with flowing water could result in significant premature wear for aromatic component 16, cause the fragrance associated with aromatic component 16 to be “used up” too fast and, depending on the material, could even cause aromatic component 16 to break apart and clog the nozzles or openings 36 in spray cap 26. Although water may “back spray” through openings 34 in base 18, such substantially incidental contact would not have the same potentially negative impacts on aromatic component 16 or shower head 12 as the flowing water.

As stated above, in a preferred embodiment of the present invention, aromatic component 16 is substantially tubular or ring shaped so that it may be easily and beneficially placed inside chamber 32. Aromatic component 16 can be made out of a variety of materials that are suitable for having a heat sensitive fragrance, such as a volatile fragrance, placed or impregnated thereon. For purposes of this disclosure the term “fragrance” includes any compound that is suitable for emanating, generating or releasing an aroma. As understood in the art, many products (such as vehicle rearview mirror fresheners, bath beads or crystals, deodorants, candles, etc.) include a fragrance component that provides a preferred aroma. Different materials can receive and hold fragrances better than others. The preferred material for aromatic component is one that will cause the fragrance associated therewith to release the aroma in response heat, such as from warm or hot water flowing through shower head 12, and not release a significant amount of aroma when no water is flowing so that the fragrance can last for a relatively significant amount of time. Although shower head 12 of the preferred embodiment is configured such that aromatic component 16 can be replaced as the fragrance is used up by unthreading spray cap 26 from base 18, most consumers will prefer that this not have to be done on a frequent basis. A preferred material for aromatic component 16 is a silicon or other similar material that is impregnated with a volatile fragrance.

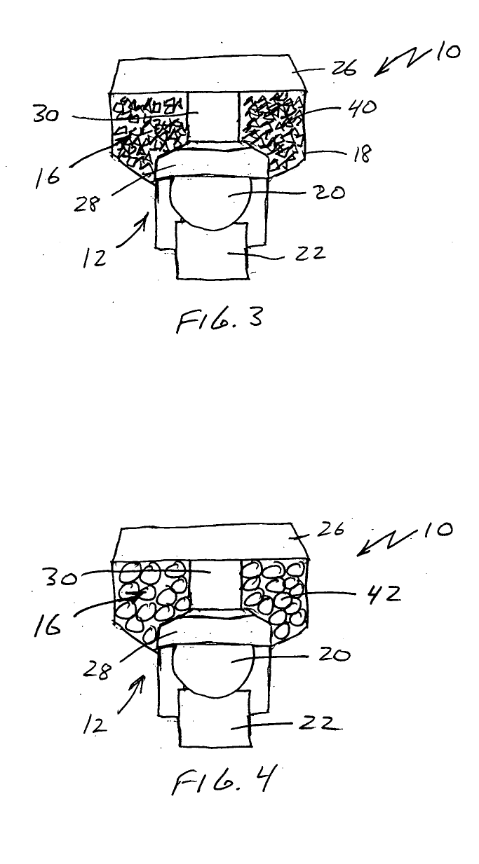

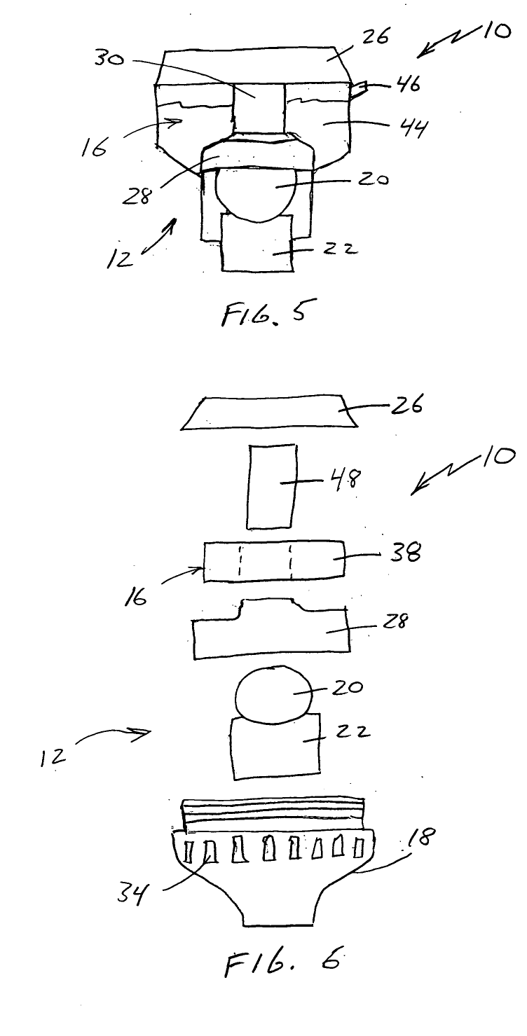

Although the preferred embodiment of aromatic component 16 is a solid or semi-solid material, shown as 38 in FIGS. 1 and 2, impregnated with a volatile fragrance and configured in a tubular or ring shape, other configurations for aromatic component 16 are also adaptable to aromatic apparatus 10 of the present invention. For instance, aromatic component 16 can be a single piece or it can comprise two or more pieces and it can be configured to substantially encircle lower section 30 of spray cap 26 or it can only partially encircle lower section 30. Alternatively, aromatic component 16 can comprise a plurality of fragrance embedded crystals 40 and/or fragrance embedded beads 42, as shown in FIGS. 3 and 4 respectively, that are configured to release the desired aroma when warm or hot water flows through shower head 12. As with a solid or semi-solid aromatic component 16, crystals 40 and beads 42 are preferably made out of materials that can receive and hold a fragrance that is suitable for releasing an aroma over time. In yet another embodiment, shown in FIG. 5, aromatic component 16 is a liquid having a fragrance or a liquid fragrance, shown as 44, that is disposed inside chamber 32 to release an aroma when warm or hot water flows through shower head 12. Naturally, base 18 and spray cap 26 should be configured such that any of the liquid material 44, as opposed to the aroma from the material 44, will not leak out of shower head 12. If desired, base 18 or spray cap 26 can include a injection port 46 (shown in FIG. 5) to allow the user to place liquid aromatic component 44 inside chamber 32. As with the solid or semi-solid embodiment, the embodiments with crystals 40, beads 42 or liquid 44 are preferably configured to allow the user to add or replace aromatic component 16 from shower head 12 as desired. In this manner, the user can add more aromatic component 16 as it is used up or, if desired, remove the aromatic component 16 inside chamber 32 and replace it with a different aromatic component 16 that emanates a different aroma.

In an alternative configuration for shower head 12, shown in FIG. 6, lower section 30 of spray cap 26 is a separate tubular member 48 that is disposed between pivot member 20 and spray cap 26 (typically with seal 28 ensuring the integrity of the flow from pivot member 20 to spray cap 26). In this configuration tubular member 48 can be removably, such as threadably, attached to spray cap 26 and affixed to base 18 or pivot member 20 so the user only needs to remove (i.e., unthread) spray cap 26 from tubular member 48 to replace aromatic component 16, such as the solid or semi-solid component 38 shown in FIG. 6, as contrasted with the tubular lower section 30 of FIGS. 1 and 2). If desired, aromatic component 16 can be affixed to tubular member 48 and tubular component 48 can be configured to be removed from shower head 12, with aromatic component 16 thereon, and replaced as a unit. Although aromatic component 16 can be affixed to lower section 30 of spray cap 26, this would require replacement of spray cap 26 or removal of aromatic component 16 from spray cap 26 in order to replace aromatic component 16 as the fragrance thereon or impregnated therein is “used up” over time.

In an alternative embodiment of aromatic apparatus 10 of the present invention, apparatus 10 is configured to attach to a tubular member, such as pipe 14, that is located outside of shower head 12. Pipe 14 may be a portion of the piping system that carries warm or hot water and extends out of the wall in a shower or tub enclosure, is located below a sink or other water basin or is specially configured for aromatic apparatus 10. As with the embodiment for inside shower head 12 described above, aromatic component 16 can be configured in a tube or ring-like structure to substantially encircle pipe 14, as shown in FIG. 7. Although aromatic component can be configured as a single tube or ring-like piece that must be slipped on and off of pipe 14 at a place where pipe 14 ends, it is preferred that aromatic component 16 be configured to open around pipe 14 and then have a closure mechanism, such as clip 50, to close aromatic component 16 on pipe 14. In this way, the user of aromatic apparatus 10 can place aromatic component 16 on pipe 14 to obtain the aromatic benefits thereof and, when necessary or desired to replace aromatic component 16, he or she can merely unlock or disengage closure mechanism 50 in order to remove aromatic component 16 from pipe 14. As may be desired, aromatic component 16 may be a solid or semi-solid material, or it may be comprised of crystals, beads or liquid aromatic material disposed inside an outer shell that is configured to substantially encircle pipe 14, as generally shown in FIG. 7. Closure mechanisms 50 suitable for securing aromatic component 16 to pipe 14 include wires, ties, hooks, clasps, Velcro®), brackets, tapes, adhesives and magnetic materials. Any closure mechanism 50 utilized should be suitable for removably securing aromatic component 16 to pipe 14 to facilitate dispersal of aroma when warm or hot water flows through pipe 14.

In a preferred embodiment of the aromatic apparatus 10 for pipe 14, aromatic component 16 is substantially flat or planar shaped and configured to be sufficiently flexible to lay over pipe 14, as shown in FIG. 8. A clip member 52 is utilized to secure aromatic component 16 to pipe 14. In the configuration shown in FIG. 8, clip member 52 comprises a frame structure 54 having a pair of end members 56 and one or more transverse members 58 interconnecting the pair of end members 56. End member 56 should be sized and configured to clasp or snap onto pipe 14 to securely hold aromatic component 16 on pipe 14. If desired, aromatic component 16 can be integral with clip member 52 (i.e., attached to frame structure 54). Flexible end members 56 would expand or open when pushed against pipe 14 and then partially close when “snapped” into place. As warm or hot water is carried by pipe 14, heat will be transferred from the fluid to aromatic component 16 to cause aromatic component 16 to dispense the desired aroma. When aromatic component 16 ceases dispensing the aroma or it is desired to change the aroma, the user merely removes clip member 52 from pipe 14 and either replaces aromatic component 16 or replaces the combination of clip member 52 and aromatic component 16. Clip member 52 can be made out of a variety of materials, such as plastics, metals, composites and the like. Although clip member 52 is shown the above-described configuration, those skilled in the art will recognize that clip member 52 can be of any number of configurations, such as having multiple transverse members 58 and other frame components. As described above, aromatic component 16 can be a silicon or other material that is impregnated, coated or covered with a volatile fragrance.

While there are shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape and use.

1. An aromatic apparatus, comprising:
a plumbing fixture having a tubular component, said tubular component configured to carry a warm or hot fluid through said plumbing fixture; and
an aromatic component at least partially disposed around said tubular component, said aromatic component configured to emanate an aroma when said warm or hot fluid is carried through said tubular component.

2. The aromatic apparatus according to claim 1, wherein said fluid is a liquid.

3. The aromatic component according to claim 1, wherein said aromatic component substantially encircles said tubular component.

4. The aromatic apparatus according to claim 1, wherein said fixture is a shower head and said aromatic component is disposed inside said shower head.

5. The aromatic apparatus according to claim 4, wherein said shower head comprises a chamber, said shower head configured to substantially enclose said aromatic component in said chamber.

6. The aromatic apparatus according to claim 5, wherein said shower head comprises one or more openings in communication with said chamber to allow aroma to emanate from said shower head.

7. The aromatic apparatus according to claim 5, wherein said aromatic component is disposed on or around a tubular component disposed inside said chamber.

8. The aromatic apparatus according to claim 5, wherein said chamber is formed by a spray cap attached to a base.

9. The aromatic apparatus according to claim 5, wherein said shower head includes means for replacing or refilling said aromatic component in said chamber.

10. The aromatic apparatus according to claim 5, wherein said shower head further comprises an injection port in communication with said chamber.

11. The aromatic apparatus according to claim 1, wherein said fixture is a pipe.

12. The aromatic apparatus according to claim 11, wherein said aromatic component comprises closure means for securing said aromatic component to said pipe.

13. The aromatic apparatus according to claim 12 further comprising a clip member for securing said aromatic component to said pipe.

14. The aromatic apparatus according to claim 13, wherein said clip member is sized and configured to securely engage said pipe.

15. The aromatic apparatus according to claim 14, wherein said clip member has a frame with a pair of end members and one or more transverse members.

16. The aromatic apparatus according to claim 1, wherein said aromatic component is impregnated with a volatile fragrance.

17. An aromatic apparatus, comprising:
a plumbing fixture having a tubular component, said tubular component configured to carry a warm or hot liquid through said plumbing fixture; and
an aromatic component at least partially disposed around said tubular component, said aromatic component impregnated with a volatile fragrance and configured to emanate an aroma when said warm or hot liquid is carried through said tubular component.

18. The aromatic apparatus according to claim 17, wherein said fixture is a shower head having a chamber therein, said aromatic component disposed inside said chamber.

19. The aromatic apparatus according to claim 17, wherein said fixture is a pipe.

20. The aromatic apparatus according to claim 19 further comprising a clip member for securing said aromatic component to said pipe, said clip member sized and configured to securely engage said pipe.
